(19) United States
(12) Patent Application Publication
(10) Pub. No.: US 2023/0124791 A1
(43) Pub. Date: Apr. 20, 2023

(54) POLYELECTROLYTE MULTILAYER MEMBRANE FOR REDOX FLOW BATTERY APPLICATIONS

(71) Applicant: UOP LLC, Des Plaines, IL (US)

(72) Inventors: Chunqing Liu, Arlington Heights, IL (US); Xueliang Dong, Schaumburg, IL (US); Chaoyi Ba, Schaumburg, IL (US)

(21) Appl. No.: 17/451,226

(22) Filed: Oct. 18, 2021

(51) Int. Cl. H01M 8/1053; H01M 8/18

(52) U.S. Cl. CPC H01M 8/1053; H01M 8/188; H01M 2008/1095

(57) ABSTRACT

A polyelectrolyte multilayer membrane has been developed for redox flow batteries and other electrochemical reaction applications. The polyelectrolyte multilayer membrane comprises an ionically conductive thin film composite membrane comprising a microporous support membrane, a hydrophilic ionomeric polymer coating layer on the surface of the microporous support membrane, and a polyelectrolyte multilayer coating on the second surface of the hydrophilic ionomeric polymer coating layer (the side opposite the support membrane). The polyelectrolyte multilayer coating comprises alternating layers of a polycation polymer and a polyanion polymer. Methods of making the polyelectrolyte multilayer membrane and redox flow battery system including the polyelectrolyte multilayer membrane are also described.

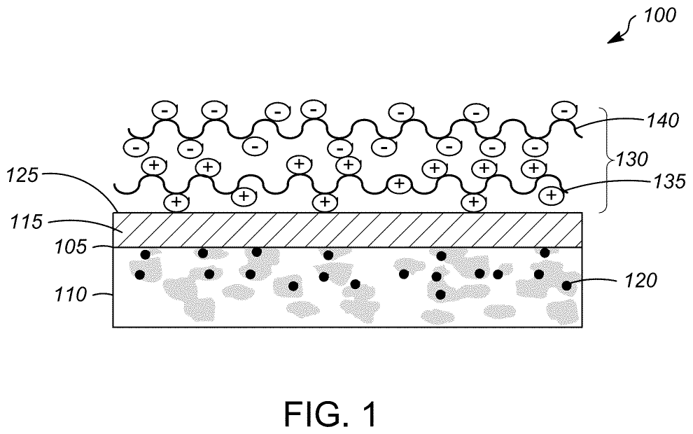

### BACKGROUND

Redox flow batteries (RFBs) comprise two external storage tanks filled with active materials comprising metal ions that may be in different valance states, two circulation pumps, and a flow cell with a separation membrane and two electrodes. The separation membrane is located between the anode and the cathode and is used to separate the anolyte and the catholyte, as well as to utilize the current circuit by allowing the transfer of balancing ions. The anolyte, catholyte, anode, and cathode may also be referred to as plating electrolyte or negative electrolyte, redox electrolyte or positive electrolyte, plating electrode or negative electrode, and redox electrode or positive electrode respectively. Among all the redox flow batteries developed to date, all vanadium redox flow batteries (VRFB) have been the most extensively studied. VRFB uses the same vanadium element in both half cells which prevents crossover contamination of electrolytes from one half cell to the other half cell. VRFB, however, is inherently expensive due to the use of high-cost vanadium and an expensive membrane. All-iron redox flow batteries (IFB) are particularly attractive for grid scale storage applications due to the use of low cost and abundantly available iron, salt, and water as the electrolyte and the non-toxic nature of the system. IFBs have iron in different valence states as both the positive and negative electrolytes for the positive and negative electrodes, respectively. The iron-based positive and negative electrolyte solutions stored in the external storage tanks flow through the stacks of the batteries. The cathode side half-cell reaction involves Fe2+ losing electrons to form Fe3+ during charge and Fe3+ gaining electrons to form Fe2+ during discharge; the reaction is given by Equation 1. The anode side half-cell reaction involves the deposition and dissolution of iron in the form of a solid plate; the reaction is given by Equation 2. The overall reaction is shown in Equation 3.

Redox electrode: 2Fe²⁺↔Fe³⁺+2e⁻+0.77V (1)

Plating electrode: Fe²⁺+2e⁻↔Fe⁰−0.44V (2)

Total: 3Fe²⁺↔Fe⁰+2Fe³⁺1.21V (3)

The membrane is one of the key materials that make up a battery or electrolysis cell and is an important driver for safety and performance. Some important properties for membranes for flow batteries, fuel cells, and membrane electrolysis include high conductivity, high ionic permeability (porosity, pore size and pore size distribution), high ionic exchange capacity (for ion-exchange membrane), high ionic/electrolyte selectivity (low permeability/crossover to electrolytes), low price (less than $150-200/m²), low area resistance to minimize efficiency loss resulting from ohmic polarization, high resistance to oxidizing and reducing conditions, chemically inert to a wide pH range, high thermal stability together with high proton conductivity (greater than or equal to 120° C. for fuel cell), high proton conductivity at high T without H₂O, high proton conductivity at high T with maintained high RH, and high mechanical strength (thickness, low swelling).

The membrane is ionically conductive. The ionic conductivity means that the membrane can transport the charge-carrying ions, such as protons or ammonium ion (NH₄⁺), from one side of the membrane to the other side of the membrane to maintain the electric circuit. The electrical balance is achieved by the transport of charge-carrying ions (such as protons, ammonium ions, potassium ions, or sodium ions in all iron redox flow battery system) in the electrolytes across the membrane during the operation of the battery cell. The ionic conductivity (σ) of the membrane is a measure of its ability to conduct charge-carrying ions, and the measurement unit for conductivity is Siemens per meter (S/m). The ionic conductivity (σ) of the ionically conductive membrane is measured by determining the resistance (R) of the membrane between two electrodes separated by a fixed distance. The resistance is determined by electrochemical impedance spectroscopy (EIS) and the measurement unit for the resistance is Ohm (Ω). The membrane area specific resistance (RA) is the product of the resistance of the membrane (R) and the membrane active area (A) and the measurement unit for the membrane area specific resistance is Ω·cm². The membrane ionic conductivity (σ, S/cm) is proportional to the membrane thickness (L, cm) and inversely proportional to the membrane area specific resistance (RA, Ω·cm²).

The performance of the RFB is evaluated by several parameters including area specific resistance, numbers of battery charge/discharge cycling, electrolyte crossover through the membrane, voltage efficiency (VE), coulombic efficiency (CE), and energy efficiency (EE) of the RFB cell. CE is the ratio of a cell's discharge capacity divided by its charge capacity. A higher CE, indicating a lower capacity loss, is mainly due to the lower rate of crossover of electrolyte ions, such as ferric and ferrous ions, through the membrane and reduced H₂ evolution reaction during charging in the iron redox flow battery system. VE is defined as the ratio of a cell's mean discharge voltage divided by its mean charge voltage (See M. Skyllas-Kazacos, C. Menictas, and T. Lim, Chapter 12 on Redox Flow Batteries for Medium- to Large-Scale Energy Storage in Electricity Transmission, Distribution and Storage Systems, A volume in Woodhead Publishing Series in Energy, 2013). A higher VE, indicating a higher ionic conductivity, is mainly due to the low area specific resistance of the battery system. EE is the product of VE and CE and is an indicator of energy loss in charge-discharge processes. EE is a key parameter to evaluate an energy storage system.

One issue for the current all iron RFB system is the high area specific resistance that results in low VE. The area specific resistance is the combination of the resistances from the membrane, the current collectors, the end plates, the electrolytes, the reactions, the interfacial resistance, and other components. Another issue is the loss of capacity in all iron RFB due to the undesired crossover of water and Fe ions through the membrane. Yet another issue is the H₂ evolution reaction during charging. H₂ is formed on the negative side of the battery as Fe²⁺ is plated on the electrode as Fe⁰, which will result in low CE. As battery is charging, hydrogen is formed on the negative side of the battery as Fe²⁺ is plated on the electrode as Fe⁰. Meanwhile, losses are minimal on positive side. Therefore, there is more Fe³⁺ in the positive solution for each cycle until there is no more Fe²⁺ available for charging the battery. The formation of H₂ resulted in low CE.

(−)Fe²⁺+2e⁻→Fe⁰ (s)E⁰=−0.44V

(−)2H⁺+2e⁻→H₂ (g)E⁰=0.00V

(+)2Fe²⁺→2Fe³⁺+2e⁻

Therefore, there is a need for improved membranes for use in RFB systems, and for methods of making them.

### BRIEF DESCRIPTION OF THE DRAWING

The FIGURE is an illustration of one embodiment of the polyelectrolyte multilayer membrane.

### DESCRIPTION OF THE INVENTION

A new polyelectrolyte multilayer membrane has been developed for redox flow batteries and other electrochemical reaction applications. The polyelectrolyte multilayer membrane has low membrane area specific resistance and significantly reduces electrolyte crossover from the positive electrolyte solution to the negative electrolyte solution. This improves VE, EE, reduces maintenance cost, and improves deliverable capacity. The polyelectrolyte multilayers may be formed using a layer-by-layer self-assembly method.

The polyelectrolyte multilayer membrane comprises an ionically conductive thin film composite membrane comprising a microporous support membrane, a hydrophilic ionomeric polymer coating layer on the surface of the microporous support membrane, and a polyelectrolyte multilayer coating on the second surface of the hydrophilic ionomeric polymer coating layer (the side opposite the support membrane). The hydrophilic ionomeric polymer coating layer is ionically conductive. There is at least one multilayer polyelectrolyte coating on the second surface of the hydrophilic ionomeric polymer coating layer. The polyelectrolyte multilayer coating comprises alternating layers of a polycation polymer and a polyanion polymer. There can be one, two, three, four, five, or more sets of alternating polycation polymer and polyanion polymer layers.

The polyelectrolyte multilayer coating may be formed via layer-by-layer self-assembly. The layer-by-layer self-assembly may be achieved by adsorption, electrostatic interactions, covalent bonds, hydrogen bonds, van der Waals forces, hydrophobic interactions, or combinations thereof. The methods for the formation of polyelectrolyte multilayer coating via layer-by-layer self-assembly may be selected from, but are not limited to, dip coating, spray deposition, centrifugal deposition, electrodeposition, meniscus/slot die coating, brushing, roller coating, metering rod/Meyer bar coating, knife casting, and the like.

The choice of the fabrication method depends on the polycation and polyanion to be assembled, the time required for the layer-by-layer self-assembly, and the shape of the ionically conductive thin film composite membrane that the polyelectrolyte multilayer coating will be deposited on. The first polyelectrolyte layer is formed by the adsorption of a polycation or polyanion on the second surface of the hydrophilic ionomeric polymer coating layer possessing opposite charges. Subsequently, the oppositely charged polyelectrolytes are alternately deposited on the second surface of the hydrophilic ionomeric polymer coating layer, with the formation of a nanostructured polyelectrolyte multilayer coating with the structure ionically conductive thin film composite membrane/(polycation/polyanion)ₙ or ionically conductive thin film composite membrane/(polyanion/polycation)ₙ, as a function of the ionic charge of the second surface of the hydrophilic ionomeric polymer coating layer. The increase in polyelectrolyte multilayer thickness depends on the number of layers deposited and can be either linear or non-linear. Several parameters, such as ionic strength, pH, temperature, polyelectrolyte structure, concentration, and charge density, can be adjusted during the layer-by-layer self-assembly process. The polyelectrolyte multilayers are insoluble and thermally and chemically stable.

The polyelectrolyte multilayer coating may be deposited on the ionically conductive thin film composite (TFC) membrane described in U.S. Provisional Patent Application No. 63/109,683, filed on Nov. 4, 2020, entitled Ionically Conductive Thin Film Composite Membranes for Energy Storage Applications, which is incorporated herein by reference in its entirety. That application disclosed a new type of low cost, high performance, ionically conductive TFC membrane comprising a hydrophilic ionomeric polymer coating layer on a microporous support membrane. The hydrophilic ionomeric polymer coating layer is a dense nonporous layer having a thickness typically in the range of about 1 micrometer to about 100 micrometers, or about 5 micrometers to about 50 micrometers. The dense hydrophilic ionomeric polymer coating layer forms very small nanopores with a pore size less than 0.5 nm in the presence of liquid water or water vapor. In some cases, combined with the existence of a cross-linked polymer structure via the complexing agent to control the swelling degree of the polymer, this results in high selectivity of charge-carrying ions such as protons, hydrated protons, chloride ions, potassium ions, hydrated potassium ions, sodium ions, and hydrated sodium ions over the electrolytes such as ferric ions, hydrated ferric ions, ferrous ions, and hydrated ferrous ions. The deposition of the polyelectrolyte multilayer coating on the ionically conductive TFC membrane resulted in improved chemical and thermal stability, reduced membrane swelling, much higher numbers of battery charge/discharge cycles, reduced electrolyte crossover through the membrane, higher VE, CE, and EE for redox flow battery applications compared to the ionically conductive TFC membrane without the polyelectrolyte multilayer coating.

The FIGURE is an illustration of the polyelectrolyte multilayer membrane 100. On the surface 105 of the microporous support membrane 110, there is a hydrophilic ionomeric polymer coating layer 115. In some cases, the hydrophilic ionomeric polymer 120 is present in the micropores of the microporous support membrane 110. On the upper surface 125 of the hydrophilic ionomeric polymer coating layer 115 (the side oppose the microporous support membrane 110), there is a polyeletrolyte multilayer coating 130. The polyeletrolyte multilayer coating 130 comprises alternating layers of a polycation polymer 135 and a polyanion polymer 140.

One aspect of the invention is a polyelectrolyte multilayer membrane. In one embodiment, the polyelectrolyte multilayer membrane comprises: a microporous support membrane; a hydrophilic ionomeric polymer coating layer on a surface of the microporous support membrane, the hydrophilic ionomeric polymer coating layer being ionically conductive, a first surface of the hydrophilic ionomeric polymer coating layer in contact with the microporous support membrane; and a polyelectrolyte multilayer coating on a second surface of the hydrophilic ionomeric polymer coating layer, the polyelectrolyte multilayer coating comprising alternating layers of a polycation polymer and a polyanion polymer.

In some embodiments, the first layer of the polyanion or polycation polymer coated on the second surface of the hydrophilic ionomeric polymer coating layer is different from the hydrophilic ionomeric polymer possessing opposite charges coated on the microporous support membrane.

The microporous support membrane should have good thermal stability (stable up to at least 100° C.), high aqueous and organic solution resistance (insoluble in aqueous and organic solutions) under low pH condition (e.g., pH less than 6), high resistance to oxidizing and reducing conditions (insoluble and no performance drop under oxidizing and reducing conditions), high mechanical strength (no dimensional change under the system operation conditions), as well as other factors dictated by the operating conditions for energy storage applications. The microporous support membrane must be compatible with the cell chemistry and meet the mechanical demands of cell stacking or winding assembly operations. The microporous support membrane has high ionic conductivity but low selectivity of charge-carrying ions such as protons, hydrated protons, chloride ions, potassium ions, hydrated potassium ions, sodium ions, and hydrated sodium ions over the electrolytes such as ferric ions, hydrated ferric ions, ferrous ions, and hydrated ferrous ions.

The microporous support membrane may comprise any suitable support membrane. Desirable characteristics of the microporous support membrane include low cost, high stability in water and electrolytes under a wide range of pH, good mechanical stability, and ease of processability for membrane fabrication. Polymers suitable for the preparation of the microporous support membrane may be selected from, but are not limited to, polyolefins such as polyethylene, polypropylene, and poly(ethylene-co-propylene), polyamide such as Nylon 6 and Nylon 6,6, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polybenzimidazole, polyimide, polyvinylidene fluoride, polycarbonate, cellulose, or combinations thereof.

The microporous support membrane can have either a symmetric porous structure or an asymmetric porous structure. The asymmetric microporous support membrane can be formed by a phase inversion membrane fabrication approach followed by direct air drying, or by phase inversion followed by solvent exchange methods. The microporous support membrane also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity, orientation, and dimension of the micropores. The wet processing of polyolefin separators is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the microporous support membrane can be in a range of 10-1000 micrometers, or a range of 10-900 micrometers, or 10-800 micrometers, or 10-700 micrometers, or 10-600 micrometers, or 10-500 micrometers, or 20-500 micrometers. The pore size of the microporous membrane can be in a range of 10 nanometers to 50 micrometers, or 50 nanometers to 10 micrometers, or 0.2 micrometers to 1 micrometer.

The hydrophilic ionomeric polymers may comprise any hydrophilic ionomeric polymers. Suitable hydrophilic ionomeric polymers include, but are not limited to, a polysaccharide polymer, a poly(acrylic acid) polymer, a poly(methacrylic acid), or combinations thereof. Suitable hydrophilic ionomeric polymers include, but are not limited to, a polysaccharide polymer, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), a poly(vinylsulfonic acid sodium) polymer, a poly(styrene sulfonate) polymer, or combinations thereof.

Suitable metal ions for complexing the polymers include, but are not limited to, ferric ions, ferrous ions, zinc ions, or vanadium ions.

Suitable polysaccharide polymers include, but are not limited to, chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

In some embodiments, the hydrophilic ionomeric polymers comprise a polyphosphoric acid-complexed chitosan polymer, a polyphosphoric acid and metal ion-complexed chitosan polymer, a metal ion-complexed alginic acid polymer, a sodium alginate polymer, an alginic acid polymer, a hyaluronic acid polymer, a poly(acrylic acid) polymer, a poly(methacrylic acid) polymer, or combinations thereof.

In some embodiments, the hydrophilic ionomeric polymers comprise a boric acid-complexed polyvinyl alcohol polymer, a boric acid-complexed alginic acid, or a blend of boric acid-complexed polyvinyl alcohol and alginic acid polymer.

The polyanion polymer in the polyelectrolyte multilayers has negative charges and can be the same or different from the hydrophilic ionomeric polymer coated on the microporous support membrane, but the polyanion polymer cannot be the first polyelectrolyte layer deposited on the second surface of the hydrophilic ionomeric polymer coated on the microporous support membrane when the hydrophilic ionomeric polymer has negative charges. The polycation polymer having positive charges will be the first polyelectrolyte layer deposited on the second surface of the hydrophilic ionomeric polymer having negative charges coated on the microporous support membrane. The polycation polymer in the polyelectrolyte multilayers has positive charges and can be the same or different from the hydrophilic ionomeric polymer coated on the microporous support membrane, but the polycation polymer cannot be the first polyelectrolyte layer deposited on the second surface of the hydrophilic ionomeric polymer coated on the microporous support membrane when the hydrophilic ionomeric polymer has positive charges. The polyanion polymer having negative charges will be the first polyelectrolyte layer deposited on the second surface of the hydrophilic ionomeric polymer having positive charges coated on the microporous support membrane. The thickness of each layer of the polyanion or polycation is less than 50 nm, or less than 20 nm, or less than 10 nm, or less than 5 nm.

The polycation polymer suitable for the preparation of the polyelectrolyte multilayer ionically conductive thin film composite membrane described in the current invention can be selected from, but is not limited to, a positively charged polysaccharide polycation polymer such as protonated chitosan, polybiguanide, quaternary ammonium polyethylenimine, quaternary ammonium polypropylenimine, quaternary ammonium polyamidoamine (PAMAM), poly(vinylamine hydrochloride) (PVH), poly(allylamine hydrochloride) (PAH), poly(amidoamine hydrochloride)), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly (4-vinylpiperidine hydrochloride), poly(diallyldimethylammonium chloride), poly(acrylamide-co-diallyldimethylammonium chloride), poly(diallyl methyl amine hydrochloride), copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(l-lysine), poly(2-methacryloyloxyethyl phosphorylcholine methacrylate)-block-poly(vinyl benzyl trimethylammonium chloride), poly[2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly[2-(trimethylamino) ethyl methacrylate chloride], poly[2-(diethylamino)ethyl methacrylate], poly[2-(dimethylamino)ethyl acrylate], or combinations thereof. The amine based polycation can be a linear, a hyperbranched, or a dendritic polymer.

The polyanion polymer suitable for the preparation of the polyelectrolyte multilayer ionically conductive thin film composite membrane described in the current invention can be selected from, but is not limited to, sodium alginate, potassium alginate, calcium alginate, ammonium alginate, alginic acid, sodium hyaluronate, potassium hyaluronate, calcium hyaluronate, ammonium hyaluronate, hyaluronic acid, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, poly(sodium phosphate), poly(styrene sulfonate), sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated poly(vinyl toluene), poly(acrylic acid), poly(vinylsulfonic acid sodium), or combinations thereof.

Another aspect of the invention is a method of preparing the polyelectrolyte multilayer membrane. In one embodiment, the method comprises: applying a layer of an aqueous solution comprising a hydrophilic ionomeric polymer to one surface of a microporous support membrane to form a hydrophilic ionomeric polymer coating layer; drying the coated membrane; and applying alternating layers of a polycation polymer and a polyanion polymer on the hydrophilic ionomeric polymer coating layer.

The hydrophilic ionomeric polymer coated on the microporous support membrane and the first polyelectrolyte coating layer comprising either a polycation polymer or a polyanion polymer on the second surface of the hydrophilic ionomeric polymer have opposite charges. As an example, the hydrophilic ionomeric polymer coated on the microporous support membrane is sodium alginate with negative charges on the polymer chains and the first polyelectrolyte coating layer comprises poly(allylamine hydrochloride) (PAH) with positive charges on the polymer chains.

The aqueous solutions of the hydrophilic ionomeric polymer, and/or the polycation polymer and the polyanion polymer may be applied by any suitable method. Suitable methods of application include, but are not limited to, dip coating, spray coating, centrifugal deposition, electrodeposition, meniscus/slot die coating, brushing, roller coating, metering rod/Meyer bar coating, knife casting, and the like.

The layer of the hydrophilic ionomeric polymer can be dried at a temperature in a range of about 40° C. to about 120° C., or about 50° C. to about 100° C.

The membrane coated with the hydrophilic ionomeric polymer may be treated with an acid solution for about 10 min to about 48 h, or about 1 h to about 24 h, or about 1 h to about 12 h, at a temperature in a range of about 20° C. to about 80° C., or about 20° C. to about 60° C., and the membrane may be rinsed with deionized water after drying the coated membrane and before applying the first layer of the polyelectrolyte solution. The treatment of the coated membrane in the acid solution either converts the water soluble polymer coating layer into a water insoluble polymer coating layer or a water insoluble acid-complexed polymer coating layer. The acid solution may comprise any suitable acid solution. Suitable acid solutions include, but are not limited to, an aqueous hydrochloric acid solution, an aqueous sulfuric acid solution, or an aqueous phosphoric acid solution.

The hydrophilic ionomeric polymer may be complexed using a complexing agent to form a cross-linked hydrophilic ionomeric polymer after drying the coated membrane and before applying the alternating layers of a polycation polymer and a polyanion polymer on the hydrophilic ionomeric polymer coating layer. The hydrophilic ionomeric polymer-coated thin film composite membrane may be immersed in an aqueous solution of the complexing agent for a time in a range of 5 min to 24 h, or 5 min to 12 h, or 5 min to 8 h, or 10 min to 5 h, or 30 min to 1 h to complex the hydrophilic ionomeric polymer with the complexing agent. The hydrophilic ionomeric polymer coated on the microporous support membrane of the polyelectrolyte multilayer membrane can also be complexed in situ with a complexing agent in a negative electrolyte, a positive electrolyte, or both the negative electrolyte and the positive electrolyte in a redox flow battery (RFB) cell.

Any suitable complexing agent that can complex with the hydrophilic ionomeric polymer to form a water insoluble cross-linked hydrophilic ionomeric polymer can be used. The water insoluble cross-linked hydrophilic ionomeric polymer coating layer provides the polyelectrolyte multilayer membrane with high stability under the RFB operating conditions. Suitable complexing agents include, but are not limited to, polyphosphoric acid, boric acid, a metal ion, or combinations thereof. The metal ion may be selected from ferric ion, ferrous ion, zinc ion, or vanadium ion, or combinations thereof.

The polyelectrolyte multilayer membrane may be treated with an acid solution for about 10 min to about 48 h, or about 1 h to about 24 h, or about 1 h to about 12 h, at a temperature in a range of about 20° C. to about 80° C., or about 20° C. to about 60° C., and the polyelectrolyte multilayer membrane may be rinsed with deionized water. The treatment of the polyelectrolyte multilayer membrane in the acid solution either converts the hydrophilic ionomeric polymer into water insoluble polymer coating layer or water insoluble acid-complexed polymer coating layer. The acid solution may comprise any suitable acid solution. Suitable acid solutions include, but are not limited to, an aqueous hydrochloric acid solution, an aqueous sulfuric acid solution, or an aqueous phosphoric acid solution.

Another aspect of the invention is a redox flow battery system. In one embodiment, the redox flow battery system comprises: at least one rechargeable cell comprising a positive electrolyte, a negative electrolyte, a cathode, an anode, and a polyelectrolyte multilayer membrane positioned between the cathode and the anode, the polyelectrolyte multilayer membrane comprising: a microporous support membrane; a hydrophilic ionomeric polymer coating layer on a surface of the microporous support membrane, the hydrophilic ionomeric polymer coating layer being ionically conductive, a first surface of the hydrophilic ionomeric polymer coating layer in contact with the microporous support membrane; and a polyelectrolyte multilayer coating on a second surface of the hydrophilic ionomeric polymer coating layer, the polyelectrolyte multilayer coating comprising alternating layers of a polycation polymer and a polyanion polymer; and wherein the cathode is in contact with the polyelectrolyte multilayer coating, wherein the cathode is in contact with the positive electrolyte, and wherein the anode is in contact with the negative electrolyte.

The first layer of the polyanion or polycation polymer coated on the second surface of the hydrophilic ionomeric polymer coating layer is different and alternate from the hydrophilic ionomeric polymer possessing opposite charges coated on the microporous support membrane.

The anode and the cathode may comprise a non-metallic or metallic electrode. Suitable non-metallic electrodes include, but are not limited to, a porous carbon felt, porous carbon paper, a porous carbon fiber paper, a carbon coated plastic mesh, or a carbon coated plastic felt. Suitable metallic electrodes include, but are not limited to, a Ti- or Fe-based electrode.

### EXAMPLE

The following examples are provided to illustrate one or more preferred embodiments of the invention but are not limited embodiments thereof. Numerous variations can be made to the following examples that lie within the scope of the invention.

### Comparative Example 1. Preparation of Alginic Acid/Daramic® Membrane (Abbreviated as AA/D Membrane)

A 8.0 wt % sodium alginate aqueous solution was prepared by dissolving sodium alginate polymer in deionized (DI) water. One surface of a Daramic® microporous support membrane purchased from Daramic, LLC was coated with a thin layer of the 8.0 wt % sodium alginate aqueous solution and dried at 60° C. for 2 h in an oven to form a sodium alginate layer on the surface of the Daramic® support membrane. The dried sodium alginate/Daramic® thin film composite (TFC) membrane was treated with 1 M HCl for 2 h to convert the sodium alginate coating layer to an alginic acid coating layer to form the alginic acid/Daramic® membrane (abbreviated as AA/D membrane)

### Example 1. Preparation of (Alginic Acid-Poly(Allylamine Hydrochloride))ₙ/Alginic Acid/Daramic® Polyelectrolyte Multilayer Membrane (Abbreviated as (AA-PAH)ₙ/AA/D Membrane)

A 8.0 wt % sodium alginate aqueous solution was prepared by dissolving sodium alginate polymer in DI water. One surface of a Daramic® microporous support membrane purchased from Daramic, LLC was coated with a thin layer of the 8.0 wt % sodium alginate aqueous solution and dried at 60° C. for 2 h in an oven to form a sodium alginate layer on the surface of the Daramic® support membrane. The dried sodium alginate/Daramic® thin film composite membrane was taped on a glass plate with the second surface of the sodium alginate coating layer facing up and the Daramic® microporous support membrane facing down and in contact with the glass plate. The second surface of the sodium alginate coating layer was immersed in a poly(allylamine hydrochloride) (PAH) polycation solution comprising NaCl and PAH polycation for about 2-3 min at room temperature. Then, the membrane was air dried for about 30 min. The dried membrane was immersed in a sodium alginate polyanion solution comprising NaCl and sodium alginate polycation for about 2-3 min followed by air drying for 30 min to form one polyelectrolyte bilayer of sodium alginate/PAH on the sodium alginate/Daramic® thin film composite. This layer-by-layer polyelectrolyte deposition process was repeated until the desired n number of polyelectrolyte bilayers were deposited on the sodium alginate/Daramic® thin film composite membrane. The final top layer can be either PAH polycation layer or sodium alginate polyanion layer. The final membrane was treated with 1 M HCl for 2 h. The treated membrane was rinsed with DI water for 3 times to form (alginic acid-poly(allylamine hydrochloride))ₙ/alginic acid/Daramic® polyelectrolyte multilayer membrane (abbreviated as (AA-PAH)ₙ/AA/D membrane) with n layers of alginic acid-PAH polyelectrolyte bilayers. As an example, (AA-PAH)₃/AA/D membrane has three layers of alginic acid-PAH polyelectrolyte bilayers deposited on the alginic acid/Daramic® thin film composite membrane.

### Example 2. All-Iron Redox Flow Battery Performance Study on AA/D Membrane and (AA-PAH)₃/AA/D Membrane

The ionic conductivity, number of battery charge/discharge cycles, VE, CE, and EE of the all-iron redox flow batteries comprising AA/D membrane as described in Comparative Example 1 and (AA-PAH)₃/AA/D as described in Example 1 were evaluated. The performance was measured using EIS with a BCS-810 battery cycling system (Biologic, FRANCE) at room temperature. The batteries used the same electrolyte formula comprising a positive electrolyte solution and a negative electrolyte solution. The positive electrolyte solution comprised 1.5 M FeCl₂, 3.5 M NH₄Cl, 0.2 M HCl, 0.1 M boric acid, and 0.2 M glycine in ultrapure water (18.2 MΩ·cm), and the pH of the solution was 0.7. The negative solution comprised 1.5 M FeCl₂, 3.5 M NH₄Cl, 0.06 M HCl, 0.1 M boric acid, and 0.2 M glycine in ultrapure water (18.2 MΩ·cm), and the pH of the solution was 1.7. The battery cell comprised the AA/D membrane or the (AA-PAH)₃/AA/D membrane, carbon felt positive and negative electrodes, positive electrolyte and negative electrolyte. The results are shown in Table 1. It can be seen from Table 1 that (AA-PAH)₃/AA/D polyelectrolyte trilayer membrane showed similar area specific resistance, much longer battery cycles, higher VE, CE, and EE than AA/D membrane without the polyelectrolyte trilayers. These results demonstrated that the (AA-PAH)₃/AA/D polyelectrolyte trilayer membrane has significantly improved performance compared to the AA/D membrane without the polyelectrolyte trilayers.

TABLE 1
All-Iron Redox Flow Battery Performance Measurements
on on AA/D membrane and (AA-PAH)₃/AA/D membrane ^{a}

| | Area Specific | | | | |
|---|---|---|---|---|---|
| | Resistance | # | VE | CE | EE |
| Membrane | (Ω · cm²) | Cycles | (%) | (%) | (%) |
| AA/D | 1.97 | 32 | 67.8 | 94.0 | 63.7 |
| (AA-PAH)₃/AA/D | 1.97 | 51 | 73.4 | 96.3 | 70.7 |

^{a} Charge current density: 30 mA/cm²; charge time: 4 h; discharge current density: 30 mA/cm²; discharge time: 4 h; # of cycles were counted with ≥70% CE.

### Specific Embodiments

While the following is described in conjunction with specific embodiments, it will be understood that this description is intended to illustrate and not limit the scope of the preceding description and the appended claims.

A first embodiment of the invention is a composition comprising a microporous support membrane; a hydrophilic ionomeric polymer coating layer on a surface of the microporous support membrane, the hydrophilic ionomeric polymer coating layer being ionically conductive, a first surface of the hydrophilic ionomeric polymer coating layer in contact with the microporous support membrane; and a polyelectrolyte multilayer coating on a second surface of the hydrophilic ionomeric polymer coating layer, the polyelectrolyte multilayer coating comprising alternating layers of a polycation polymer and a polyanion polymer. An embodiment of the invention is one, any or all of prior embodiments in this paragraph up through the first embodiment in this paragraph wherein the hydrophilic ionomeric polymer comprises a polysaccharide polymer, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a poly(acrylic acid) polymer, a metal ion-complexed poly(acrylic acid) polymer, a boric acid-complexed poly(acrylic acid) polymer, a poly(methacrylic acid) polymer, a metal ion-complexed poly(methacrylic acid), a boric acid-complexed poly(methacrylic acid), a poly(vinylsulfonic acid sodium) polymer, a poly(styrene sulfonate) polymer, or combinations thereof. An embodiment of the invention is one, any or all of prior embodiments in this paragraph up through the first embodiment in this paragraph wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof. An embodiment of the invention is one, any or all of prior embodiments in this paragraph up through the first embodiment in this paragraph wherein the metal ion is ferric ion, ferrous ion, zinc ion, or vanadium ion. An embodiment of the invention is one, any or all of prior embodiments in this paragraph up through the first embodiment in this paragraph wherein there are at least two sets of the alternating layers. An embodiment of the invention is one, any or all of prior embodiments in this paragraph up through the first embodiment in this paragraph wherein the polyanion polymer is the same as the hydrophilic ionomeric polymer. An embodiment of the invention is one, any or all of prior embodiments in this paragraph up through the first embodiment in this paragraph wherein the polyanion polymer comprises sodium alginate, potassium alginate, calcium alginate, ammonium alginate, alginic acid, sodium hyaluronate, potassium hyaluronate, calcium hyaluronate, ammonium hyaluronate, hyaluronic acid, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, poly(sodium phosphate), poly(styrene sulfonate), sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated poly(vinyl toluene), poly(acrylic acid), poly(vinylsulfonic acid sodium), or combinations thereof. An embodiment of the invention is one, any or all of prior embodiments in this paragraph up through the first embodiment in this paragraph wherein the polycation polymer comprises protonated chitosan, polybiguanide, quaternary ammonium polyethylenimine, quaternary ammonium polypropylenimine, quaternary ammonium polyamidoamine (PAMAM), poly(vinylamine hydrochloride) (PVH), poly(allylamine hydrochloride) (PAH), poly(amidoamine hydrochloride)), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly (4-vinylpiperidine hydrochloride), poly(diallyldimethylammonium chloride), poly(acrylamide-co-diallyldimethylammonium chloride), poly(diallyl methyl amine hydrochloride), copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(l-lysine), poly(2-methacryloyloxyethyl phosphorylcholine methacrylate)-block-poly(vinyl benzyl trimethylammonium chloride), poly[2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly[2-(trimethylamino) ethyl methacrylate chloride], poly[2-(diethylamino)ethyl methacrylate], poly[2-(dimethylamino)ethyl acrylate], or combinations thereof. An embodiment of the invention is one, any or all of prior embodiments in this paragraph up through the first embodiment in this paragraph wherein the support membrane comprises polyethylene, polypropylene, polyamide, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polybenzimidazole, polyimide, polyvinylidene fluoride, polycarbonate, cellulose, or combinations thereof. An embodiment of the invention is one, any or all of prior embodiments in this paragraph up through the first embodiment in this paragraph wherein the hydrophilic ionomeric polymer is present in the micropores of the support membrane.

A second embodiment of the invention is a method of preparing polyelectrolyte multilayer membrane comprising applying a layer of an aqueous solution comprising a hydrophilic ionomeric polymer to one surface of a microporous support membrane to form a hydrophilic ionomeric polymer coating layer; drying the coated membrane; and applying alternating layers of a polycation polymer and a polyanion polymer on the hydrophilic ionomeric polymer coating layer. An embodiment of the invention is one, any or all of prior embodiments in this paragraph up through the second embodiment in this paragraph wherein the hydrophilic ionomeric polymer comprises a polysaccharide polymer, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a poly(acrylic acid) polymer, a metal ion-complexed poly(acrylic acid) polymer, a boric acid-complexed poly(acrylic acid) polymer, a poly(methacrylic acid) polymer, a metal ion-complexed poly(methacrylic acid), a boric acid-complexed poly(methacrylic acid), a poly(vinylsulfonic acid sodium) polymer, a poly(styrene sulfonate) polymer, or combinations thereof. An embodiment of the invention is one, any or all of prior embodiments in this paragraph up through the second embodiment in this paragraph wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof. An embodiment of the invention is one, any or all of prior embodiments in this paragraph up through the second embodiment in this paragraph further comprising complexing the hydrophilic ionomeric polymer using a complexing agent to form a cross-linked hydrophilic ionomeric polymer after drying the coated membrane and before applying the alternating layers of a polycation polymer and a polyanion polymer on the hydrophilic ionomeric polymer coating layer. An embodiment of the invention is one, any or all of prior embodiments in this paragraph up through the second embodiment in this paragraph wherein the complexing agent is selected from polyphosphoric acid, boric acid, a metal ion selected from ferric ion, ferrous ion, zinc ion, or vanadium ion, or combinations thereof. An embodiment of the invention is one, any or all of prior embodiments in this paragraph up through the second embodiment in this paragraph wherein there are at least two sets of the alternating layers. An embodiment of the invention is one, any or all of prior embodiments in this paragraph up through the second embodiment in this paragraph wherein the polyanion polymer is the same as the hydrophilic ionomeric polymer. An embodiment of the invention is one, any or all of prior embodiments in this paragraph up through the second embodiment in this paragraph wherein the polyanion polymer comprises sodium alginate, potassium alginate, calcium alginate, ammonium alginate, alginic acid, sodium hyaluronate, potassium hyaluronate, calcium hyaluronate, ammonium hyaluronate, hyaluronic acid, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, poly(sodium phosphate), poly(styrene sulfonate), sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated poly(vinyl toluene), poly(acrylic acid), poly(vinylsulfonic acid sodium), or combinations thereof. An embodiment of the invention is one, any or all of prior embodiments in this paragraph up through the second embodiment in this paragraph wherein the polycation polymer comprises protonated chitosan, polybiguanide, quaternary ammonium polyethylenimine, quaternary ammonium polypropylenimine, quaternary ammonium polyamidoamine (PAMAM), poly(vinylamine hydrochloride) (PVH), poly(allylamine hydrochloride) (PAH), poly(amidoamine hydrochloride)), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly (4-vinylpiperidine hydrochloride), poly(diallyldimethylammonium chloride), poly(acrylamide-co-diallyldimethylammonium chloride), poly(diallyl methyl amine hydrochloride), copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(l-lysine), poly(2-methacryloyloxyethyl phosphorylcholine methacrylate)-block-poly(vinyl benzyl trimethylammonium chloride), poly[2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly[2-(trimethylamino) ethyl methacrylate chloride], poly[2-(diethylamino)ethyl methacrylate], poly[2-(dimethylamino)ethyl acrylate], or combinations thereof.

A third embodiment of the invention is an apparatus, comprising at least one rechargeable cell comprising a positive electrolyte, a negative electrolyte, a cathode, an anode, and a polyelectrolyte multilayer membrane positioned between the cathode and the anode, the polyelectrolyte multilayer membrane comprising a microporous support membrane; a hydrophilic ionomeric polymer coating layer on a surface of the microporous support membrane, the hydrophilic ionomeric polymer coating layer being ionically conductive, a first surface of the hydrophilic ionomeric polymer coating layer in contact with the microporous support membrane; and a polyelectrolyte multilayer coating on a second surface of the hydrophilic ionomeric polymer coating layer, the polyelectrolyte multilayer coating comprising alternating layers of a polycation polymer and a polyanion polymer; and wherein the cathode is in contact with the polyelectrolyte multilayer coating, wherein the cathode is in contact with the positive electrolyte, and wherein the anode is in contact with the negative electrolyte.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A polyelectrolyte multilayer membrane comprising:
a microporous support membrane;
a hydrophilic ionomeric polymer coating layer on a surface of the microporous support membrane, the hydrophilic ionomeric polymer coating layer being ionically conductive, a first surface of the hydrophilic ionomeric polymer coating layer in contact with the microporous support membrane; and
a polyelectrolyte multilayer coating on a second surface of the hydrophilic ionomeric polymer coating layer, the polyelectrolyte multilayer coating comprising alternating layers of a polycation polymer and a polyanion polymer.

2. The membrane of claim 1 wherein the hydrophilic ionomeric polymer comprises a polysaccharide polymer, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a poly(acrylic acid) polymer, a metal ion-complexed poly(acrylic acid) polymer, a boric acid-complexed poly(acrylic acid) polymer, a poly(methacrylic acid) polymer, a metal ion-complexed poly(methacrylic acid), a boric acid-complexed poly(methacrylic acid), a poly(vinylsulfonic acid sodium) polymer, a poly(styrene sulfonate) polymer, or combinations thereof.

3. The membrane of claim 2 wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

4. The membrane of claim 3 wherein the metal ion is ferric ion, ferrous ion, zinc ion, or vanadium ion.

5. The membrane of claim 1 wherein there are at least two sets of the alternating layers.

6. The membrane of claim 1 wherein the polyanion polymer is the same as the hydrophilic ionomeric polymer.

7. The membrane of claim 1 wherein the polyanion polymer comprises sodium alginate, potassium alginate, calcium alginate, ammonium alginate, alginic acid, sodium hyaluronate, potassium hyaluronate, calcium hyaluronate, ammonium hyaluronate, hyaluronic acid, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, poly(sodium phosphate), poly(styrene sulfonate), sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated poly(vinyl toluene), poly(acrylic acid), poly(vinylsulfonic acid sodium), or combinations thereof.

8. The membrane of claim 1 wherein the polycation polymer comprises protonated chitosan, polybiguanide, quaternary ammonium polyethylenimine, quaternary ammonium polypropylenimine, quaternary ammonium polyamidoamine (PAMAM), poly(vinylamine hydrochloride) (PVH), poly(allylamine hydrochloride) (PAH), poly(amidoamine hydrochloride)), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly (4-vinylpiperidine hydrochloride), poly(diallyldimethylammonium chloride), poly(acrylamide-co-diallyldimethylammonium chloride), poly(diallyl methyl amine hydrochloride), copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(l-lysine), poly(2-methacryloyloxyethyl phosphorylcholine methacrylate)-block-poly(vinyl benzyl trimethylammonium chloride), poly[2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly[2-(trimethylamino) ethyl methacrylate chloride], poly[2-(diethylamino)ethyl methacrylate], poly[2-(dimethylamino)ethyl acrylate], or combinations thereof.

9. The membrane of claim 1 wherein the support membrane comprises polyethylene, polypropylene, polyamide, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polybenzimidazole, polyimide, polyvinylidene fluoride, polycarbonate, cellulose, or combinations thereof.

10. The membrane of claim 1 wherein the hydrophilic ionomeric polymer is present in the micropores of the support membrane.

11. A method of preparing polyelectrolyte multilayer membrane comprising:
applying a layer of an aqueous solution comprising a hydrophilic ionomeric polymer to one surface of a microporous support membrane to form a hydrophilic ionomeric polymer coating layer;
drying the coated membrane; and
applying alternating layers of a polycation polymer and a polyanion polymer on the hydrophilic ionomeric polymer coating layer.

12. The method of claim 11 wherein the hydrophilic ionomeric polymer comprises a polysaccharide polymer, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a poly(acrylic acid) polymer, a metal ion-complexed poly(acrylic acid) polymer, a boric acid-complexed poly(acrylic acid) polymer, a poly(methacrylic acid) polymer, a metal ion-complexed poly(methacrylic acid), a boric acid-complexed poly(methacrylic acid), a poly(vinylsulfonic acid sodium) polymer, a poly(styrene sulfonate) polymer, or combinations thereof.

13. The method of claim 12 wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

14. The method of claim 11 further comprising:
complexing the hydrophilic ionomeric polymer using a complexing agent to form a cross-linked hydrophilic ionomeric polymer after drying the coated membrane and before applying the alternating layers of a polycation polymer and a polyanion polymer on the hydrophilic ionomeric polymer coating layer.

15. The method of claim 11 wherein the complexing agent is selected from polyphosphoric acid, boric acid, a metal ion selected from ferric ion, ferrous ion, zinc ion, or vanadium ion, or combinations thereof.

16. The method of claim 11 wherein there are at least two sets of the alternating layers.

17. The method of claim 11 wherein the polyanion polymer is the same as the hydrophilic ionomeric polymer.

18. The method of claim 11 wherein the polyanion polymer comprises sodium alginate, potassium alginate, calcium alginate, ammonium alginate, alginic acid, sodium hyaluronate, potassium hyaluronate, calcium hyaluronate, ammonium hyaluronate, hyaluronic acid, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, poly(sodium phosphate), poly(styrene sulfonate), sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated poly(vinyl toluene), poly(acrylic acid), poly(vinylsulfonic acid sodium), or combinations thereof.

19. The method of claim 11 wherein the polycation polymer comprises protonated chitosan, polybiguanide, quaternary ammonium polyethylenimine, quaternary ammonium polypropylenimine, quaternary polyamidoamine (PAMAM), poly(vinylamine hydrochloride) (PVH), poly(allylamine hydrochloride) (PAH), poly(amidoamine hydrochloride)), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly (4-vinylpiperidine hydrochloride), poly(diallyldimethylammonium chloride), poly(acrylamide-co-diallyldimethylammonium chloride), poly(diallyl methyl amine hydrochloride), copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(l-lysine), poly(2-methacryloyloxyethyl phosphorylcholine methacrylate)-block-poly(vinyl benzyl trimethylammonium chloride), poly[2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly[2-(trimethylamino) ethyl methacrylate chloride], poly[2-(diethylamino)ethyl methacrylate], poly[2-(dimethylamino)ethyl acrylate], or combinations thereof.

20. A redox flow battery system, comprising:
at least one rechargeable cell comprising a positive electrolyte, a negative electrolyte, a cathode, an anode, and a polyelectrolyte multilayer membrane positioned between the cathode and the anode, the polyelectrolyte multilayer membrane comprising:
a microporous support membrane;
a hydrophilic ionomeric polymer coating layer on a surface of the microporous support membrane, the hydrophilic ionomeric polymer coating layer being ionically conductive, a first surface of the hydrophilic ionomeric polymer coating layer in contact with the microporous support membrane; and
a polyelectrolyte multilayer coating on a second surface of the hydrophilic ionomeric polymer coating layer, the polyelectrolyte multilayer coating comprising alternating layers of a polycation polymer and a polyanion polymer; and
wherein the cathode is in contact with the polyelectrolyte multilayer coating, wherein the cathode is in contact with the positive electrolyte, and wherein the anode is in contact with the negative electrolyte.
